(19) United States
(12) Patent Application Publication
(10) Pub. No.: US 2002/0082799 A1
(43) Pub. Date: Jun. 27, 2002

(54) Measuring transducer with a corrected output signal

(75) Inventor: Robin Pramanik, Karlsruhe (DE)

Correspondence Address: SUGHRUE MION, PLLC, 2100 Pennsylvania Avenue, NW, Washington, DC, 20037-3213, US

(73) Assignee: SIEMENS AG

(21) Appl. No.: 10/032,449

(22) Filed: Jan. 2, 2002

Related U.S. Application Data
(63) Continuation of application No. PCT/DE00/02026, filed on Jun. 21, 2000.

(30) Foreign Application Priority Data
Jul. 2, 1999 (DE) 199 30 661.3

(51) Int. Cl. G01K 1/00; G01K 3/00; G01K 5/00; G01K 7/00; G01K 9/00; G01K 11/00; G01K 13/00; G06F 15/00; G01K 17/00

(52) U.S. Cl. 702/130

(57) ABSTRACT

In a transducer, a sensor signal (2) is digitized and subsequently processed in an arithmetic-logic unit (7) into a setpoint value (A), which is finally converted into an analog output signal (I). The output signal (I) is detected, digitized and then supplied to the arithmetic-logic unit (7), which determines any deviation between the output signal (I) and the setpoint value (A). This makes it possible to determine and display the measuring error of the transducer in the conversion of the digital setpoint value (A) into the analog output signal (I) and, where necessary, to correct it in the arithmetic-logic unit (7).

This is a Continuation of International Application PCT/DE00/02026, with an international filing date of Jun. 21, 2000, which was published under PCT Article 21 (2) in German, and the disclosure of which is incorporated into this application by reference.

### FIELD OF THE INVENTION

The present invention generally relates to a measuring transducer operable to convert a measured quantity into an analog output signal that can be transmitted over a two-wire line. In particular, the present invention relates to a measuring transducer that has a sensor, an analog-to-digital converter connected to the sensor, an arithmetic-logic unit, and an output circuit that is controlled by the arithmetic-logic unit and can be connected to the two-wire line.

### BACKGROUND OF THE INVENTION

A typical measuring transducer without the disclosed improvements of the present invention is illustrated in SIEMENS Catalogue MP 17, 1999 and is referred to as SITRANS P DS. The measuring transducer disclosed in this catalogue has a pressure sensor with a sensor signal that is amplified, digitized and subsequently evaluated in a microcontroller and adjusted with respect to linearity and temperature behavior. In an output circuit with a digital-to-analog converter the sensor signal thus processed is converted into an analog output signal, in this case an output current in the range of 4 to 20 mA, and transmitted over a two-wire line to an evaluation unit, for instance in a control system. The output circuit further comprises a data interface for sending and receiving frequency-modulated signals over the two-wire line using the HART protocol.

In accordance with the conventional transducer mentioned above, the conversion of the processed digital sensor signal into the analog output signal is subject to thermal influences and aging-related changes resulting in a measuring error of the transducer. To compensate for the temperature behavior in the context of digital processing of the sensor signal, it is possible to use correction values that are determined by complex temperature runs. Accordingly, the temperature of the transducer electronics is detected by means of a separate temperature sensor, whose temperature sensor signal is also digitized and evaluated in the microcontroller. Alternatively, temperature compensation can also be performed using analog circuitry within the output circuit by means of complex networks. In accordance with the above-mentioned conventional transducer, the long-term stability of the transducer can be ensured by using low-drift and, thus, expensive components.

### OBJECTS OF THE INVENTION

One object of the invention is to provide a measuring transducer that detects, and subsequently corrects, the measuring error of the transducer.

Another object of the invention is to provide a measuring transducer that corrects the measuring error of the transducer using the simplest possible means.

### SUMMARY OF THE INVENTION

According to the invention, the objects mentioned above as well as others are achieved by providing a measuring transducer that converts the measured quantity into a sensor signal, which is then digitized in the analog-to-digital converter and processed into a setpoint value in the arithmetic-logic unit. The setpoint value is then used in the output circuit to adjust the analog output signal on the two-wire line.

Further, a transducer in accordance with the invention can detect the analog output signal and supply this signal, or a signal derived directly therefrom, to the analog-to-digital converter, or a secondary analog-to-digital converter. The arithmetic-logic unit is configured to determine any deviation between the output signal and the setpoint value. With the analog-to-digital converter, which is used to digitize the sensor signal, a measuring unit that is typically very precise and stable over the long term is available in the transducer. The measuring unit is used in the present invention to determine the measuring error that occurs when the setpoint value is converted into the analog output signal. Further, the measuring error can be communicated to the user. To this end, the inventive transducer is preferably equipped with a data interface and/or a display device to transmit or display information regarding the determined deviation and thus the measuring error. The data interface is preferably an integral component of the output circuit and allows data communication over the two-wire line using at least the HART protocol.

The aforementioned secondary analog-to-digital converter is important especially if the analog-to-digital converter that digitizes the sensor signal is also intended to provide electrical isolation between the sensor and transducer electronics. Such analog-to-digital converters, for example, voltage-frequency converters, are relatively complex, so that the use of a secondary simple analog-to-digital converter used to digitize the analog output signal, or the signal derived therefrom, is of particular value.

To compensate for the measuring error determined in the transducer, the arithmetic-logic unit of the transducer is preferably configured to correct the setpoint value as a function of the determined deviation between the output signal and the setpoint value in such a way that the deviation between the output signal adjusted by the corrected setpoint and the non-corrected setpoint becomes minimal. In this correction, temperature influences and the long-term behavior of the transducer are equally taken into consideration, so that time-consuming temperature runs can be eliminated and long-term stability is improved. At the same time, components that are less stable over the long term and therefore less expensive can be used.

The sensor signal and the analog output quantity, or the signal derived therefrom, can be alternately supplied to the analog-to-digital converter via a multiplexer. Alternatively, a multi-channel analog-to-digital converter may be used, and the sensor signal and the output signal, or the signal derived therefrom, can be supplied, respectively, to different inputs of the analog-to-digital converter. This does not increase the complexity of the equipment since, as mentioned above, the analog-to-digital converter used in the prior art transducer processes not only the actual desired signal but also an additional signal, in particular, the signal of the temperature sensor in the transducer electronics.

### BRIEF DESCRIPTION OF THE DRAWINGS

The invention will now be described in greater detail with reference to the drawing figures in which;

FIG. 1 is a simplified circuit diagram of a first exemplary embodiment of the transducer according to the invention, and

FIG. 2 is an example of the adjustment of the output signal of the transducer, and

FIG. 3 is a simplified circuit diagram of an additional exemplary embodiment of the transducer according to the invention.

### DETAILED DESCRIPTION OF THE PREFERRED EMBODIMENTS

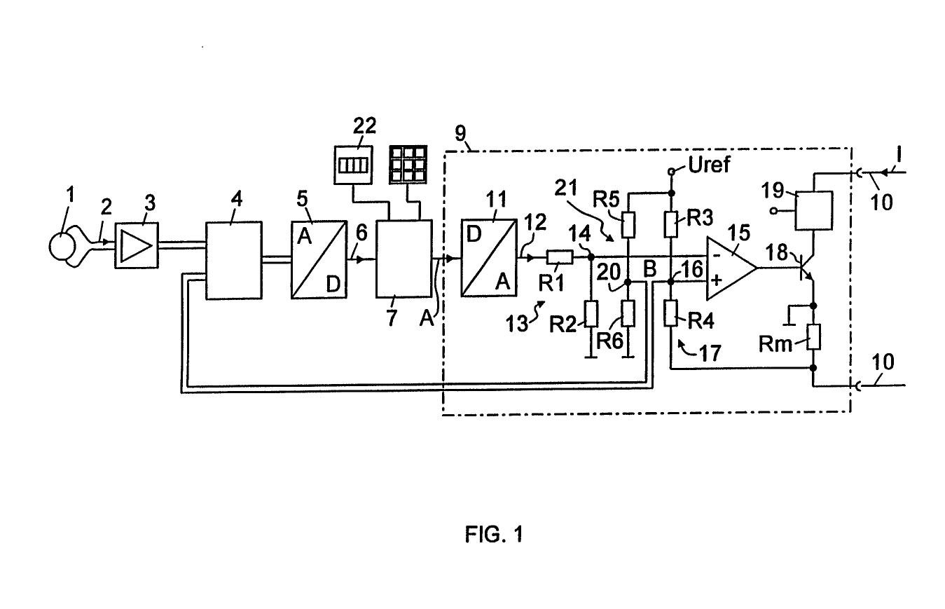

According to one embodiment of the invention, the transducer shown in FIG. 1 has a sensor 1, which detects a measured quantity, for instance pressure, at a measuring location (not shown) in a technical installation and converts the measured quantity into an electrical sensor signal 2. The sensor signal 2, via a signal amplifier 3 and a multiplexer 4, is supplied to an analog-to-digital converter 5, which converts the analog sensor signal 2 into a digital signal 6. The digitized sensor signal 6 is supplied to an arithmetic-logic unit 7, in this case a microcontroller, in which the sensor signal 6 is processed, e.g. linearized and scaled, into a digital setpoint value A. Setpoint value A is used in an output circuit 9 of the transducer to set an analog output signal, in this case a current I between 4 and 20 mA on a two-wire line 10 connected to the output circuit 9. To this end, the output circuit 9 comprises a digital-to-analog converter 11, which converts the digital setpoint value A into an analog setpoint value 12. This analog setpoint value 12 is applied as a voltage or current to two resistors R1 and R2 that are connected in series. The resistors R1 and R2 form a voltage divider 13, to the center tap 14 of which the inverted input of an operational amplifier 15 is connected. The non-inverting input of the operational amplifier 15 is connected to a tap 16 of an additional voltage divider 17, which on one side of tap 16 is formed by a resistor R3 and on the other side of tap 16 by two resistors R4 and Rm connected in series. A stable reference voltage Uref is applied to the voltage divider 17. The output of the operational amplifier 15 controls a transistor 18, which with its collector-emitter path is arranged in the current path of the two-wire line 10. Resistor Rm of voltage divider 17, used as a standard resistor for current I, is also integrated in this current path in such a way that current I is fed back as a voltage drop at resistor Rm to the non-inverted input of the operational amplifier 15, which controls transistor 18 in terms of an adjustment of current I to the setpoint value 12 predefined by the digital-to-analog converter 11. Current I is transmitted as an analog output signal of the transducer over the two-wire line 10 to an evaluation unit (not shown) of a control system of the technical installation. In addition, a power supply unit 19 that generates the supply voltage for the transducer from current I is also arranged in the current path of the two-wire line 10.

Conversion of the digital setpoint value A into the output signal I on the two-wire line 10 may be subject to errors due to temperature and long-term influences. The resulting measuring error of the transducer is detected as a deviation between the setpoint value A and the actual output signal I. To this end, the output signal I, or in this case a signal derived therefrom, is detected, digitized in the analog-to-digital converter 5 and compared with the digital setpoint value A in the arithmetic-logic unit 7. Digitization of the output signal I, or the signal derived therefrom, is possible without any appreciable additional complexity because a highly precise measuring unit with long-term stability is already available with the analog-to-digital converter 5. The measurement resolution and accuracy of the analog-to-digital converter 5, with, for example, 13 bits of data in this case, is significantly greater than that of the output circuit 9 whose digital-to-analog converter 11 has a resolution of, for example, 10 bits of data. One reason for this is that the sensor signal 2 must be detected with a higher resolution and accuracy in order to be able to compensate for any non-linearities of sensor 1 in the arithmetic-logic unit 7. Another reason is that frequently only a portion of the measuring range of sensor 1 is to be mapped to the control range of output current I. For example, if a pressure of 0 to 4 bar can be measured with sensor 1, but only a partial range of 2 to 3 bar is to be mapped to the control range of 4 to 20 mA of the output circuit 9, the analog-to-digital converter 5 must have a resolution of 13 bits to be able to digitize the partial range of 2 to 3 bar with a resolution of 11 bits.

To detect the signal derived from output signal I in the exemplary embodiment shown here, the differential voltage B between tap 16 of voltage divider 17 and a tap 20 of an additional voltage divider 21, which is formed by two resistors R5 and R6 and which is also on the reference voltage Uref, is supplied to the analog-to-digital converter 5 via multiplexer 4. By adjusting the resistances R3, R4, Rm, R5 and R6 in the two voltage dividers 17 and 21, it is possible to make the differential voltage B between taps 16 and 20 independent of the reference voltage Uref and its possible inaccuracy, so that it depends only on current I and the values of the resistors in the voltage dividers 17 and 21. In the arithmetic-logic unit 7, the digital setpoint value A and the digitized differential voltage B are used to calculate the measuring error of the transducer. This measuring error can be output on a display unit 22 of the transducer or as a frequency-modulated signal via output circuit 9 to the two-wire line 10 using the HART protocol.

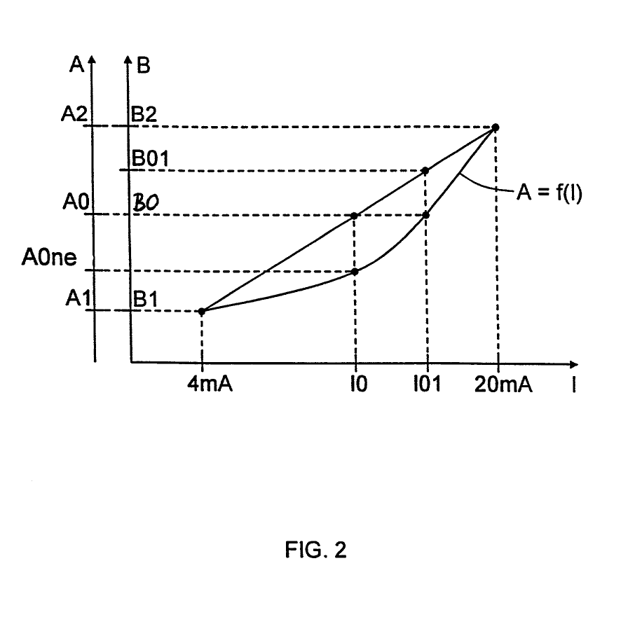

In accordance with a further embodiment of the invention, the measuring error can be taken into account in the arithmetic-logic unit 7 when calculating the setpoint value A and, thus, the measuring error can thereby be minimized. FIG. 2 illustrates this further embodiment of the invention. Referring to FIG. 2, if the transducer operates flawlessly, the key values 4 mA and 20 mA of the control range of the output signal I are successively adjusted with setpoint values A1 and A2 and the associated values B1 and B2 of the differential voltage B between the voltage divider taps 17 and 20 (shown in FIG. 1) are determined.

For an output signal I this results in a differential voltage value BX=B1+I (B2−B1) (20 mA-4 mA), which in arithmetic-logic unit 7 is used to calculate the value of the output signal I with I=(20 mA-4 mA) (B-B1)/(B2-B1).

If the transducer operates flawlessly, a value I0 of the output signal I is established for a setpoint value A0; the associated differential voltage value B0 is used to calculate the output signal value 10 in arithmetic-logic unit 7. As a function of temperature, a relationship A=F(I) that is no longer linear may result between setpoint value A and the output signal I adjusted therewith, so that an output signal 101 is adjusted for the setpoint value A0. The arithmetic-logic unit 7 uses the associated differential voltage value B01 to calculate the output signal I01 and the difference ΔI=I0-I01. As a function of ΔI, the setpoint value A0 can now be incrementally changed until the output signal value I0 is established for a new setpoint value A0 new. If the functional relationship A=F(I) is approximately known, the new setpoint value A0 new can be calculated also in a single step with A0 new=A0−(df(I)/dI)•ΔI.

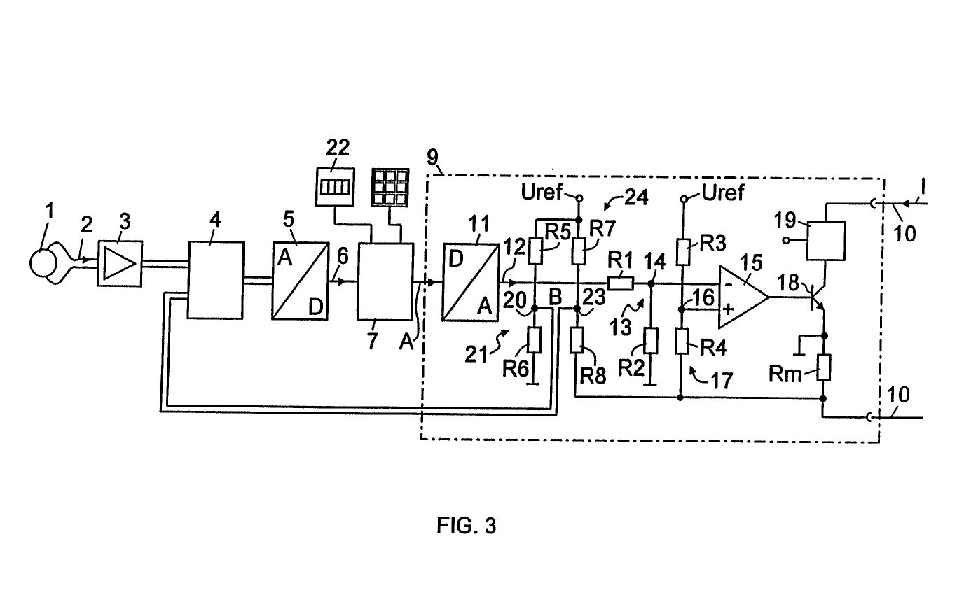

FIG. 3 shows another exemplary embodiment of the inventive transducer. The transducer depicted in FIG. 3 differs from the transducer depicted in FIG. 1 in that the differential voltage B is detected between voltage divider tap 20 and tap 23 of an additional voltage divider 24, which on the one side of tap 23 comprises a resistor R7 and on the other side of tap 23 comprises a resistor R8 in series with the standard resistor Rm and which is on reference voltage Uref. As a result, the adjustment of the output signal I and the detection of the differential voltage B are decoupled from one another, so that the resistors of the voltage divider 13, 17 and 21, 24 can be optimally adjusted independently from one another.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A measuring transducer operable to transmit an analog output signal over a two-wire line, said transducer comprising:
a sensor operable to convert a measured quantity into a sensor signal;
an analog-to-digital converter connected to said sensor and operable to digitize the sensor signal;
an arithmetic-logic unit operable to process the digitized sensor signal into a setpoint value; and
an output circuit controlled by said arithmetic-logic unit and connectable to the two-wire line, wherein the setpoint value is used to adjust, in said output circuit, the analog output signal on the two-wire line, said output circuit comprising a plurality of resistors which detect the analog output signal and supply the analog output signal, or a signal derived directly therefrom, to said analog-to-digital converter, and said arithmetic-logic unit is configured to determine any deviation between the analog output signal and the setpoint value.

2. A measuring transducer as claimed in claim 1, further comprising:
a data interface operable to transmit or display information regarding the determined deviation.

3. A measuring transducer as claimed in claim 1, wherein said arithmetic-logic unit is operable to correct the setpoint value as a function of the determined deviation in such a way that the deviation between the analog output signal that is adjusted with the corrected setpoint value and a non-corrected setpoint value is minimized.

4. A measuring transducer as claimed in claim 1, further comprising a multiplexer, wherein the sensor signal and the analog output signal, or the signal derived therefrom, are supplied to said analog-to-digital converter via said multiplexer.

5. A measuring transducer as claimed in claim 1, wherein the sensor signal and the analog output signal, or the signal derived therefrom, are each supplied to different inputs of said analog-to-digital converter.

6. A measuring transducer operable to transmit an analog output signal over a two-wire line, said transducer comprising:
a sensor operable to convert a measured quantity into a sensor signal;
an analog-to-digital converter connected to said sensor and operable to digitize the sensor signal;
an arithmetic-logic unit operable to process the digitized sensor signal into a setpoint value; and
an output circuit controlled by said arithmetic-logic unit and connectable to the two-wire line, wherein the setpoint value is used to adjust, in said output circuit, the analog output signal on the two-wire line, said output circuit comprising a resistor means which detects the analog output signal and supplies the analog output signal, or a signal derived directly therefrom, to said analog-to-digital converter, and said arithmetic-logic unit is configured to determine any deviation between the analog output signal and the setpoint value.
